(19) United States
(12) Patent Application Publication
(10) Pub. No.: US 2016/0226983 A1
(43) Pub. Date: Aug. 4, 2016

(54) SYSTEM AND METHOD FOR COMPUTATION OF RELEVANCE OF AN INDIVIDUAL WITH A CAMPAIGN IN SOCIAL MEDIA

(71) Applicant: Internatonal Business Machines Corporation, Armonk, NY (US)

(72) Inventor: Jalal U. Mahmud, San Jose, CA (US)

(73) Assignee: International Business Machines Corporation, Armonk, NY (US)

(21) Appl. No.: 14/133,831

(22) Filed: Dec. 19, 2013

(51) Int. Cl. H04L 29/08; H04L 12/58

(52) U.S. Cl. CPC H04L 67/22; H04L 51/32; H04L 51/38

(57) ABSTRACT

A method and system determines relevance of a person in relation to a social media campaign using a communications system. A group of users can be determined based on a selection criteria. Each of the users has communications on the social network which are related to an issue of a social media campaign. The selection criteria is based on a relevancy to the issue of the communications. Using a computer, each of the users of the group of users is scored using a scoring technique for determining each user's relevance to the issue based on their communications. The scoring technique is based on grading a plurality of attributes for each of the users. Each user of the group of users is ranked according to their score using the scoring technique, the scoring technique can further include a cumulative attribute score based on the grading of the plurality of attributes.

### STATEMENT REGARDING FEDERALLY SPONSORED RESEARCH OF DEVELOPMENT

This invention was made with Government support under Contract No.: W911NF-12-C-0028 awarded by Army Research Office (ARO). The Government has certain rights in the invention.

### BACKGROUND

The present disclosure relates to a method and system for determining relevance of a person in a social media campaign using a communications network, and more particularly, includes scoring attributes of each of the users of a social network. Social media can include known types of electronic communication, for example, emails, postings on a social forum, websites, and texting, wherein multiple users exchange information using electronic devices. Businesses and organizations can be interested in social media to engage with potential audiences, for example, through various messaging campaigns. For example, businesses can run marketing campaigns to influence their target customers. Governments and various organizations can launch campaigns with specific objectives, e.g., to raise public safety, raise awareness about an issue, such as an environmental campaign, political campaign, etc. Through such media campaigns, businesses and organizations often want to achieve a certain objective, e.g., increasing brand awareness for a marketing campaign, achieving marketing growth, achieving a desired campaign growth or information spreading rate. Organizations may want to affect/influence a campaign which spreads information to counter other spreading media information.

### SUMMARY

According to an aspect of the invention, a method for determining relevance of a person in relation to a social media campaign uses a communications system, and includes determining a group of users based on a selection criteria. The group of users communicate on a social network of a communications system. Each of the users has communications on the social network which are related to an issue of a social media campaign. The selection criteria can be based on the communications relevancy to the issue. The method includes scoring each of the users of the group of users using a scoring technique for determining each user's relevance to the issue based on their communications. The scoring technique can be based on grading a plurality of attributes for each of the users, and the attributes are relevant to the issue. The method also includes ranking each of the users of the group of users according to a cumulative attribute score, based on the grading of the plurality of attributes for each of the users, using a computer.

In another aspect of the invention, a computer program product includes a computer readable storage medium having program code embodied therewith, the program code is executable by a processor to: determining a group of users based on a selection criteria, using the computer, the group of users communicating on a social network of a communications system, each of the users having communications on the social network which are related to an issue of a social media campaign, the selection criteria being based on a relevancy to the issue of the communications; scoring each of the users of the group of users using a scoring technique for determining each users' relevance to the issue based on their communications, the scoring technique being based on grading a plurality of attributes for each of the users, the attributes being relevant to the issue; and ranking, using the computer, each of the users of the group of users according to their score using the scoring technique, the scoring technique further including a cumulative attribute score based on the grading of the plurality of attributes for each of the users.

In another aspect of the invention, a system includes: a memory having computer readable computer instructions; and a processor for executing the computer readable instructions, the instruction including: determining a group of users based on a selection criteria, using the computer, the group of users communicating on a social network of a communications system, each of the users having communications on the social network which are related to an issue of a social media campaign, the selection criteria being based on a relevancy to the issue of the communications; scoring each of the users of the group of users using a scoring technique for determining each users' relevance to the issue based on their communications, the scoring technique being based on grading a plurality of attributes for each of the users, the attributes being relevant to the issue; and ranking, using the computer, each of the users of the group of users according to their score using the scoring technique, the scoring technique further including a cumulative attribute score based on the grading of the plurality of attributes for each of the users.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram for illustrating an overview of a system and methodology for determining relevance of a person in relation to a social media campaign using a communications network, according to an embodiment of the disclosure;

FIG. 2 is a flow chart illustrating a method for determining relevance of a person in relation to a social media campaign using the system shown in FIG. 1, according to an embodiment of the disclosure;

FIG. 3 is a functional block diagram illustrating functions related to the system and method shown in FIGS. 1 and 2, according to an embodiment of the disclosure; and

FIG. 4 is a detail block diagram of program modules shown in FIG. 1, according to an embodiment of the disclosure.

### DETAILED DESCRIPTION

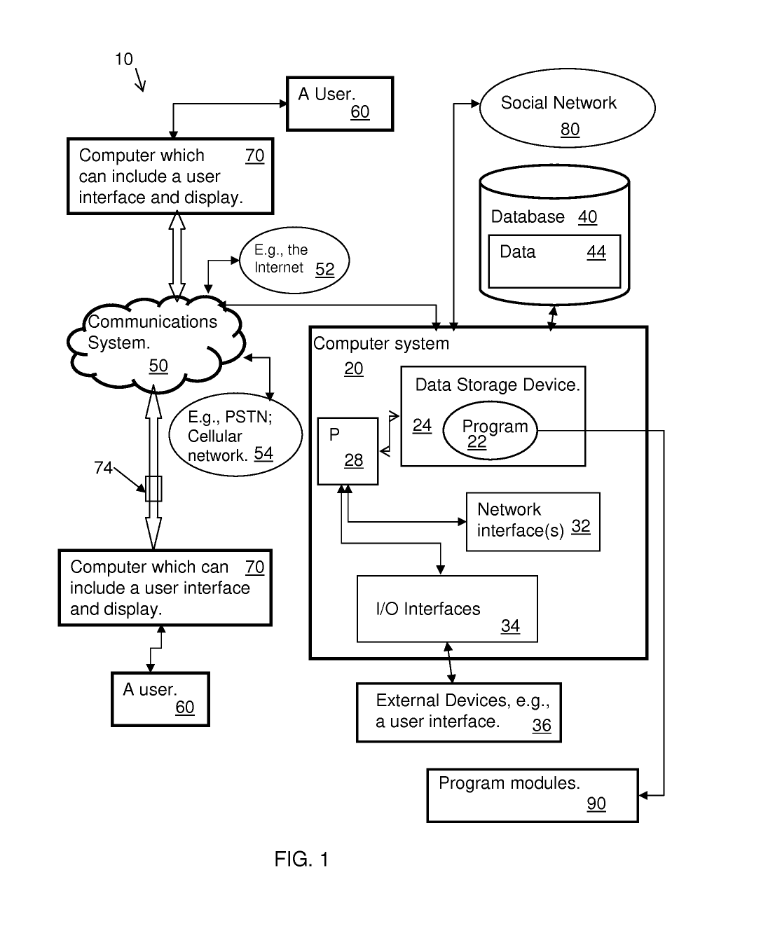

Referring to FIGS. 1-3 a system 10 and method 100, according to an embodiment of the disclosure, is directed to determining relevance of a person in a social media campaign which uses a communications network.

A campaign can be defined as a collection of social media users and their posts bound together by some common objective, e.g., promoting a product, criticizing a politician, or inserting disinformation into an online discussion. A campaign in a social media space can have a nucleating event (the thing that ‘triggered’ the campaign), and can have a call to action (proposal to do something about it). Campaigns worth following differ over industry, companies, and even divisions within companies. There is no one-size-fits-all approach to selecting relevant campaigns. A campaign can be discovered through a guided process where a subject matter expert (SME), and/or the ultimate consumer of the information, explore and defines the characteristics that are of interest to them in discovering relevant campaigns. In one aspect of the present disclosure, a framework is created for a system that interacts with a SME to define exclusion criteria, provide explicit and implicit feedback, and infer additional features for selection and ranking of relevant campaigns with the goal to ultimately provide the SME with a list of campaigns that they should be aware of.

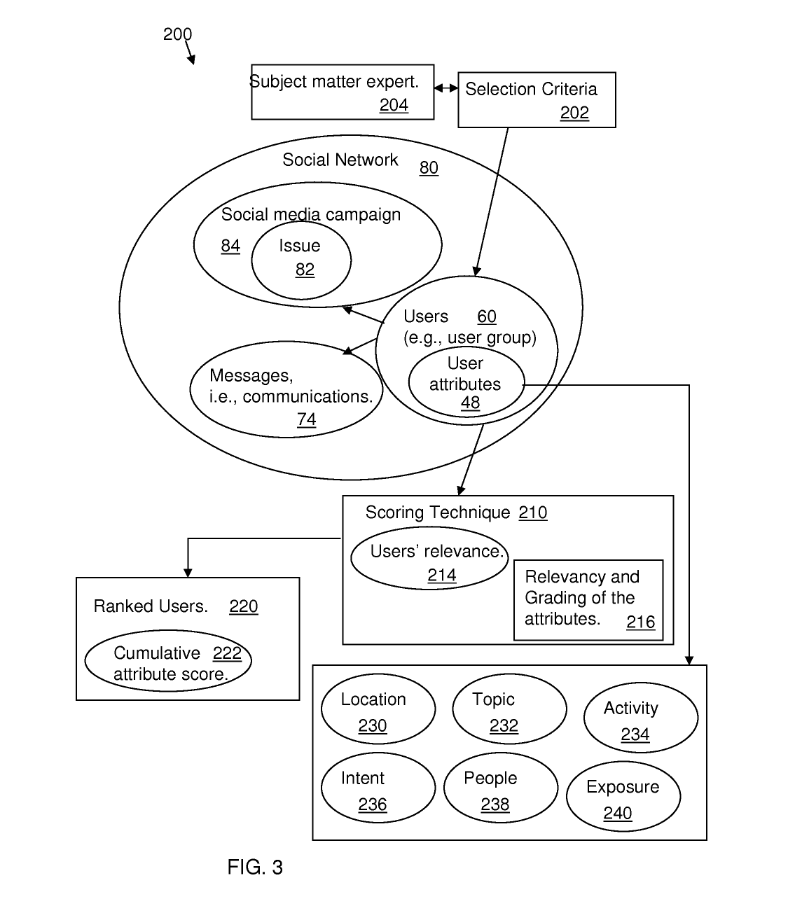

Step 104 includes determining a group of users based on a selection criteria 202 (shown in FIG. 3). The group of users are represented as users 60 in FIG. 1 and FIG. 3. The group of users communicate on a social network 80 accessible using a communications system or network 50. Each of the users has communications on the social network 80 which are related to an issue 82 of a social media campaign 84. The selection criteria 202 is based on the communications relevancy to the issue 82. The communications can be, for example, emails, text messaging, or posting text, and are generically represented by electronic message 74 shown in FIGS. 1 and 3. Messaging may include a message thread between multiple users, or messaging can include data, such as a message, photo, or text uploaded to a social media website.

The use of the term step or steps, or method steps, refers to elements and features of the embodiment(s) of the method(s) and system(s) of the present disclosure, and is not limiting to a sequence.

The selection criteria 202 and determining the communications relevancy to the issue 82 can be, for example, determined by a subject matter expert. The users 60 (shown in FIGS. 1 and 3) are representative of a plurality of users which may include, for example, several users or dozens or even hundreds of users. Each of the users 60 have access to a communication device, which can be embodied as a computer 70, for example, a mobile device. For example, communications devices can include: a computer, or Personal Data Assistant (PDA), notebook, a tablet, a cell phone, or other mobile device, a laptop, a netbook, or a car communication system. The multiple users 60 computers 70 can communicate with a communications system 50. The computers 70 can send an electronic message, such as a text or an email.

Electronic messages can use the communications system 50, which can include, the Internet 52, or a public switched telephone network (PSTN) for example, a cellular network 54. The PSTN may include telephone lines, fiber optic cables, microwave transmission links, cellular networks, and communications satellites. Exemplary messaging services may include Short Message Service (SMS) which is a text messaging service component of phone, web, or mobile communication systems, using standardized communications protocols which allows the exchange of short text messages between fixed line or mobile phone devices. The Internet may facilitate numerous communications, such as email, and texting techniques, for example, using a cell phone or laptop computer to send text messages via Multimedia Messaging Service (MMS) (related to SMS) as one technique to send messages that include multimedia content to and from mobile phones, or to and from one or more email accounts via the Internet.

The method 100 may be embodied in a program 22 embodied on a computer readable storage device, e.g., data storage device 24, and is executable by a processor 28 of a computer 20 (i.e., execute program steps, code, or program code). The program or executable instructions therefrom, may be offered as a service by a provider. The program may also be stored and run locally on a user device. The computer 20 and program 22 shown in FIG. 1 are generic representations of a computer and program that may be local to a user, or provided as a remote service, such as a website accessible using the Internet. It is understood that the computer 20 also generically represent herein a computer device such a personal data assistant, a laptop, or desktop computer, etc., or part of one or more servers, alone or as part of a datacenter. The computer system 20 can include a network interface 32, and input/output (I/O) interface(s) 34. The I/O interface 34 allows for input and output of data with an external device 36 that may be connected to the computing device. The network interface 32 may provide communications between the computing device and a computer network. The computer system 20 can be part of a service for providing the method disclosed herein as a service.

Referring to FIG. 1, data 44, for example, user data as part of the social network, user attributes, relevance of communications to the issue, or score data, can be saved in a database 40.

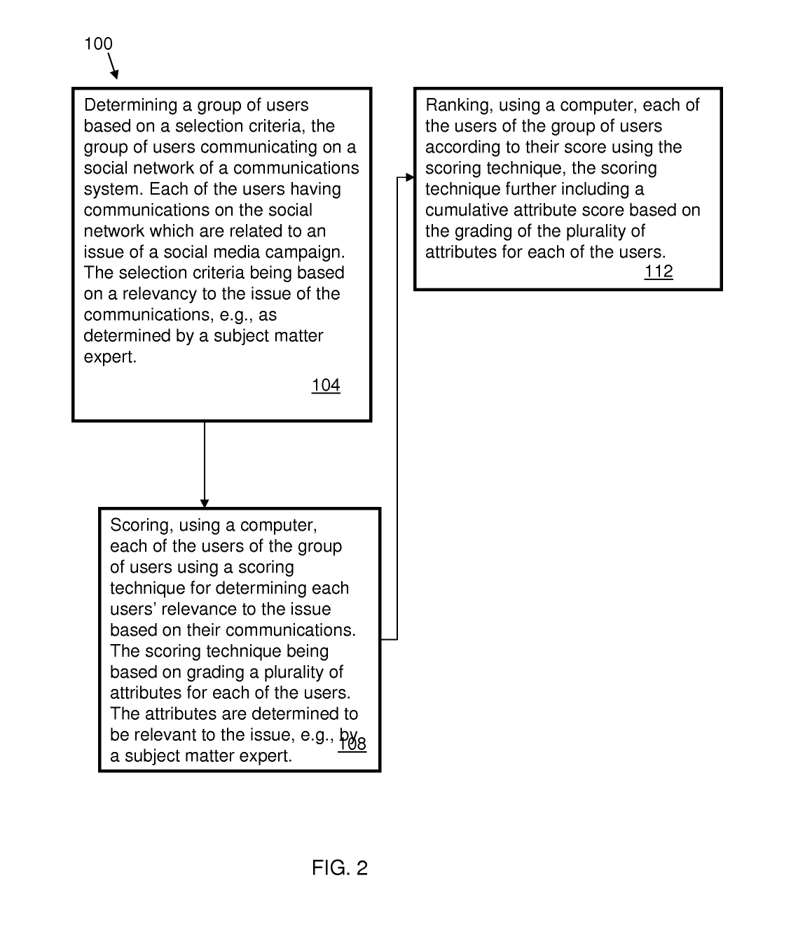

The method 100, shown in FIG. 2, includes scoring each of the users 60 of the group of users using a scoring technique 214 for determining each users' relevance 214 to the issue 82 based on their communications, as in step 108. The scoring technique 210 can be based on grading 216 (or accessing) a plurality of attributes 48 for each of the users. The attributes 48 are relevant to the issue, and can be determined, for example, by a subject matter expert. The attributes can include a location, a topic, an activity, a frequency of contact, a user's intent, or relevancy of users contacted. The attributes for each of the users can include personality attributes or traits.

Step 112 includes ranking 220 each user of the group of users 60 according to a cumulative attribute score 222 based on the grading 216 of the plurality of attributes 48 for each of the users 60, using a computer 20. For example, each of the users of the group can be ranked according to their score using the scoring technique. The scoring technique can further include the cumulative attribute score based on the grading of the plurality of attributes for each of the users.

The grading can include assigning a number to each of the attributes to indicate its importance to the issue. The cumulative attribute score can be the total number assignment for each attribute. The cumulative attribute score can be a statistically based score or a rule based score.

In one embodiment of the disclosure, the method 100 can be implemented using a computer which can include a user device, such as a laptop or personal computer, which can have a program implementing the method locally on the user device. In another embodiment the method 100 can be implemented using a server which can be remote and can be associated with a network (or web) based service.

In one embodiment of the present disclosure, the selection criteria 202 can be generated using a subject matter expert 204. The selection criteria can include using frequency of communications, one or more locations, communication connections, e.g., friendships within the social network. The attributes 48 and their relevancy to the issue 82 and the grading 216 of the attributes based on relevancy, can also be determined using a subject matter expert 204.

Thereby, the present disclosure discloses a method and system for achieving a media campaign objective, wherein suitable individuals in social media are identified for strategic communication (including communicating a media campaign, and spreading a message or counter message). One example of such strategic communication is to send marketing offers or promotions. Another example is to send a message to counter an existing campaign (e.g., a company might want to reduce a potential affect of a negative campaign against it by initiating a positive campaign. Another example includes organizing a campaign to gain more followers of an issue or spread awareness of an issue to more people. One advantage of the present disclosure is in providing a technique for identifying individuals who are relevant for a campaign. Such relevant individuals could be engaged in a strategic communication towards the media campaign.

Individuals may be influential about a topic by many techniques, and evaluated by numerous methods of assessment. For example, a user can be the most influential regarding a topic by frequently posting about a topic of a campaign, by having messages forwarded frequently, or by having many followers. Such approaches may find the most active (or most influential) individuals related to a campaign. However, the present disclosure additionally identifies and initiates communication with users with specific attributes or property who can also be relevant for a campaign. Such individuals can be important for businesses and organizations to identify since they can be easier to influence in strategic communication. Furthermore, identifying such individuals help grow the reach of the campaign (e.g., a marketing message). In addition, for a strategic communication, it is often desirable to find people with different qualities (e.g., living in a certain location, trustworthy, dutiful, loyal) who are relevant with an existing campaign. The present disclosure includes finding, influential users relevant to a campaign in addition to frequent users.

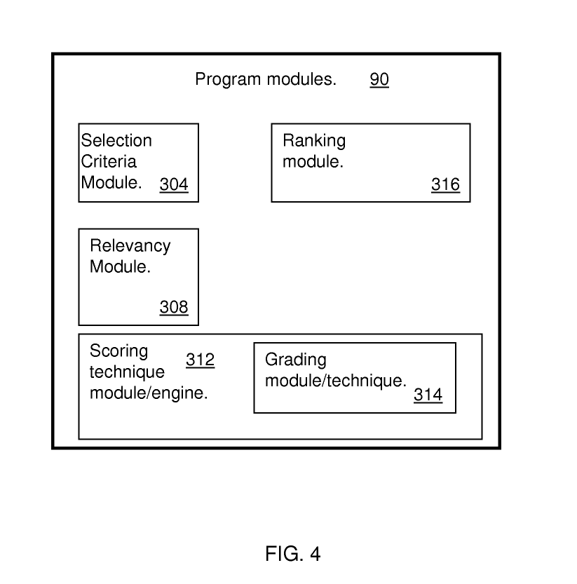

The program 22 may include program modules 90 for executing specific steps, routines, sub-routines, instructions or code, of the program 22. Such modules 90 are generically represented in FIG. 1. For example, an embodiment of the use of program modules 90 is shown in a more detailed block diagram in FIG. 4. The program modules 90 can include a selection criteria module 304 for determining a group of users based on the selection criteria 202. In this scenario, the program 22 can use a supplied criteria and based on the criteria, generate a group of users.

A relevancy module 308 can be used to determine relatedness 216 of attributes 48 of the users to one or more issues of a social media campaign. A scoring technique module 312 can be used to score each of the users of the group of users to determine each users' relevance to the issue of the social campaign. The scoring technique can include a grading module/technique 314 which grades a plurality of attributes for each of the users.

A ranking module 316 can rank each user of the group of users according to a cumulative attribute score, thereby providing a ranked list of users who are the relevant to one or more issues of a media campaign.

An embodiment of the disclosure includes computing relevance of an individual within an existing campaign in social media. A subject matter expert can determine user attributes and their relevance to one or more issues in the social media. A list of users can be extracted from users of a social media, random sampling from a social stream, or generated from keyword used by social media users. Each of the users on the list of users can be ranked according to attributes which are determined to be relevant to an issue, for example, a social campaign, target audience, or a strategic communication.

Examples of relevancy of attributes can include: relevance with locality of the campaign, relevance with specific individuals (such as leaders/followers) of a campaign, relatedness with the temporal activity of the campaign, and relatedness of intent of the campaign.

The relevancy of the attributes can be used for computing the overall relevance of an individual in relation to a campaign.

Scoring for user based on their attributes can be derived and a combined score generated using a rule based or machine learning based approach.

Examples of attributes and their relevancy to an issue are discussed herein below. The attributes can be characterized as relatedness to one or more issues of a campaign. A location can be related to one or more issues of a medial campaign. The location 230 (FIG. 3) can be useful for campaigns which are specific to a location (e.g., organizing a rally, a sporting event, promoting a local brand). For a user, such location consisted of home-location, where a person lives, works or a current location. A location of a user may be supplied by a user or indirectly ascertained, for example, using the location of a user's device.

Another attribute of a user can be an exposure 240 such as a direct exposure, e.g., to information, a place, or thing. A direct exposure can include a user who discloses their location, e.g., by profile information, geo tags (using a GPS (Global Positioning System)) or geo location services.

An indirect exposure attribute can include determining a user's location indirectly. For example, the user's location can be determined from their messages, e.g., mention of place or names, or tagging important words in a message.

Relevancy and/or topic relatedness 232 can be generated between a user and a campaign. A set of topical words for the campaign can be supplied by a subject matter expert, and a topical overlap can be computed, including: keyword based matching from a user's social media posts; keyword based matching from a user's conversations in social media; and re-posting another user's posts who mention the topics/keywords.

Another type of attribute and relevancy includes people relatedness 238. People relatedness can capture a user's communications with a specific person (e.g., leaders/influencers) who is involved in a campaign or a involved with an issue of interest. Leaders/influencers of a campaign can be determined by an SME, or identified by using a rule-based method. A strong connection to a specific person can be based on, for example: a direct friendship on social media; a length of the friendship; an indirect social network relationship; a social engagement through conversation and re-posting, etc.; a location proximate to a campaign leader; and a relationship through similar personality traits.

In order to determine an indirect social relationship, a personality assessment or computation of campaign leaders can be performed, and a personality computation of the individual under consideration can be performed. Personality assessment can be accomplished by analyzing social media posts, and using state-of-the-art dictionary-based and a Big Five correlation approach. Big Five refers to personality traits and personality models which psychologists have developed. The Big Five personality model includes characterizing a person's traits from five aspects: openness, conscientiousness, extraversion, agreeableness, and neuroticism. The Big Five personality dimensions are five broad dimensions that can characterize a personality score. Together the Big Five personality dimensions can be used to identify the traits and structure of a personality. Each Big Five personality dimension is associated with lower level facets, which are specific and unique aspects of the broader personality dimension, as illustrated in Table 1 below.

TABLE 1

| Big Five Personality | |
|---|---|
| Dimensions | Lower Level Facets |
| Neuroticism | Anxiety, Anger, Depression, Self-consciousness, |
| | Immoderation, Vulnerability |
| Extraversion | Friendliness, Gregariousness, Assertiveness, Activity |
| | level, Excitement-seeking, Cheerfulness |
| Openness | Imagination, Artistic interests, Emotionality, |
| | Adventurousness, Intellect, Liberalism |
| Agreeableness | Trust, Morality, Altruism, Cooperation, Modesty, |
| | Sympathy |
| Conscientiousness | Self-efficacy, Orderliness, Dutifulness, Achievement- |
| | striving, Self-discipline, Cautiousness |

Another attribute is activity relatedness 234. Activity relatedness is similar to similarity between a user's activity and campaign activity. Activity relatedness can be a temporal similarity and can be determined from users' messages, re-posting activity, and a campaign participant's messaging, or re-posting activity. The activity of the campaign for use in a relevancy computation can be determined, for example, by computing a mean/median time of messaging activity, a peak time of messaging activity, or a peak time of messaging by campaign leaders, etc.

Another attribute is intent relatedness 236. Intent relatedness can include a similarity of a users' intent with the campaign intent or goal. The similarity can be computed based on analysis of a user's social media posts, with domain specific rules that describe the intent of the campaign. Furthermore, intent relatedness may be captured from: social conversations (e.g., question-asking) that describe an intent of a person; re-posting others posts that express intent; or re-posting an update which points to a URL which is relevant to the campaign.

Based on the scores computed by one or more of the above attributes or features, a rule based or machine learning based approach can rank users/people. In one instance, an SME can select individuals from the ranked list for strategic communication. When training a machine learning based model for ranking, prior knowledge about relevant individual can be used as ground truth (e.g., relevant/not-relevant, or relevance probability 0.7). An SME may also select/de-select features which should be used for computation of relevance according to the need.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for determining relevance of a person in relation to a social media campaign using a communications system, comprising:
determining a group of users based on a selection criteria, the group of users communicating on a social network of a communications system, each of the users having communications on the social network which are related to an issue of a social media campaign, the selection criteria being based on a relevancy to the issue of the communications;
scoring, using a computer, each of the users of the group of users using a scoring technique for determining each user's relevance to the issue based on their communications, the scoring technique being based on grading a plurality of attributes for each of the users, the attributes being relevant to the issue; and
ranking, using the computer, each of the users of the group of users according to their score using the scoring technique, the scoring technique further including a cumulative attribute score based on the grading of the plurality of attributes for each of the users.

2. The method of claim 1, wherein the selection criteria is generated using a subject matter expert.

3. The method of claim 1, wherein the attributes and the grading are determined using a subject matter expert.

4. The method of claim 1, wherein the relevancy attributes include: a location; a topic; an activity; a frequency of contact; a user's intent; relevancy of users contacted.

5. The method of claim 1, wherein the relevancy of the attributes to the issue is determined by a subject matter expert.

6. The method of claim 1, wherein the cumulative attribute score is either a statistical based score or a rule based score.

7. The method of claim 1, wherein the scoring is based on a machine learning model.

8. The method of claim 1, wherein the attributes for each of the users includes personality attributes.

9. The method of claim 1, wherein the score for each of the users is based on one or more of the attributes which include: a location relatedness; a topic relatedness; an activity relatedness; an intent relatedness; and a people relatedness.

10. A computer program product comprising a computer readable storage medium having program code embodied therewith, the program code is executable by a processor to:
determining a group of users based on a selection criteria, using the computer, the group of users communicating on a social network of a communications system, each of the users having communications on the social network which are related to an issue of a social media campaign, the selection criteria being based on a relevancy to the issue of the communications;
scoring each of the users of the group of users using a scoring technique for determining each users' relevance to the issue based on their communications, the scoring technique being based on grading a plurality of attributes for each of the users, the attributes being relevant to the issue; and
ranking, using the computer, each of the users of the group of users according to their score using the scoring technique, the scoring technique further including a cumulative attribute score based on the grading of the plurality of attributes for each of the users.

11. The computer program product of claim 10, wherein the selection criteria is generated using a subject matter expert.

12. The computer program product of claim 10, wherein the attributes and the grading are determined using a subject matter expert.

13. The computer program product of claim 10, wherein the relevancy attributes include: a location; a topic; an activity; a frequency of contact; a user's intent; relevancy of users contacted.

14. The computer program product of claim 10, wherein the relevancy of the attributes to the issue is determined by a subject matter expert.

15. The computer program product of claim 10, wherein the cumulative attribute score is either a statistical based score or a rule based score.

16. The computer program product of claim 10, wherein the attributes for each of the users includes personality attributes.

17. The computer program product of claim 10, wherein the score for each of the users is based on one or more of the attributes which include: a location relatedness; a topic relatedness; an activity relatedness; an intent relatedness; and a people relatedness.

18. A system, comprising:
a memory having computer readable computer instructions; and
a processor for executing the computer readable instructions, the instruction including:
determining a group of users based on a selection criteria, using the computer, the group of users communicating on a social network of a communications system, each of the users having communications on the social network which are related to an issue of a social media campaign, the selection criteria being based on a relevancy to the issue of the communications;
scoring each of the users of the group of users using a scoring technique for determining each users' relevance to the issue based on their communications, the scoring technique being based on grading a plurality of attributes for each of the users, the attributes being relevant to the issue; and
ranking, using the computer, each of the users of the group of users according to their score using the scoring technique, the scoring technique further including a cumulative attribute score based on the grading of the plurality of attributes for each of the users.

19. The system of claim 18, wherein the attributes and the grading are determined using a subject matter expert.

20. The system of claim 18, wherein the relevancy attributes include: a location; a topic; an activity; a frequency of contact; a user's intent; relevancy of users contacted.
